(19) United States
(12) Patent Application Publication
(10) Pub. No.: US 2008/0118355 A1
(43) Pub. Date: May 22, 2008

(54) Turbine Vane for Turbo-Machines and Method for Fabricating

(75) Inventors: Tilo Buttner, Ot Herzduri (DE); Gunnar Walther, Dresden (DE); Thomas Weissgarber, Dresden (DE); Michael Schutze, Aschaffenburg (DE); Dirk Naumann, Ontario (CA); Alexander Bohm, Hanichen (DE)

Correspondence Address: INCO PATENTS & LICENSING, PARK 80 WEST - PLAZA TWO, SADDLE BROOK, NJ, 07663, US

(73) Assignees: CVRD INCO LIMITED, Toronto, ON (CA); FRAUNHOFER-GESELLSCAHAFT ZUR FORDERUNG DER ANGEWANDTEN FORSCHUNG E.V., Munchen (DE)

(21) Appl. No.: 11/813,706

(22) PCT Filed: Jan. 13, 2006
(86) PCT No.: PCT/EP06/00279

§ 371 Date: Dec. 19, 2007

(30) Foreign Application Priority Data
Jan. 14, 2005 (DE) 10 2005 002 671.0

(51) Int. Cl. F01D 5/14; F01D 5/28; B23P 15/04

(52) U.S. Cl. 416/95; 416/241 R; 29/889.71

(57) ABSTRACT

A turbine blade for turbo-engines as well as a method for manufacturing such a turbine blade is disclosed. According to the task set, the turbine blades should be capable of withstanding high thermal stress and able to maintain an adequate mechanical strength even at raised operating temperatures. The turbine blades are so designed that on the surface of a core element a heat-insulating layer of a metallic open-cell foam is integrally connected to said core element by sintering. The outer contour of the turbine blade is formed with at least one shell element. The shell element comprises a nickel-base alloy, which is also integrally connected by sintering to the open-cell foam which forms the heat-insulating layer.

The invention relates to turbine blades for turbo-engines and to a suitable method for manufacturing same. The turbine blades according to the invention are suitable for long-term use at raised operating temperatures.

Turbine blades of turbo-engines are frequently subjected to high thermal stress and an adequate strength must be maintained even at the raised operating temperatures of up to 1000° C. Moreover such turbine blades should have as low a mass as possible in order to be able to keep as small as possible the forces acting on the turbine bearings and the centrifugal forces acting directly on the individual turbine blades.

Turbines are therefore manufactured from metals or even metal alloys which are as heat-resistant as possible and have as low a physical density as possible. Frequently such turbine blades are also provided with surface coatings, materials which have high temperature stability and as little thermal conductivity as possible being used for this purpose. Thus for example there is a known way of spraying ceramics onto such turbine blades and thus forming a heat-insulating layer.

However, it is known that problems arise with such surface coatings since they tend to flake off especially when temperature changes occur and thus the turbines can be damaged or even completely destroyed.

The object of the invention, therefore, is to make available turbine blades for turbo-engines which can withstand high thermal stress and maintain adequate mechanical strength even at raised operating temperatures.

This object is accomplished according to the invention with turbine blades which have the features of claim 1. They can be manufactured by means of a method according to claim 8.

Advantageous embodiments and developments of the invention can be achieved with the features described in the subordinate claims.

The turbine blades according to the invention are here manufactured from at least three essential individual elements which are integrally connected to each other by sintering and correspondingly form what is termed a “composite part”.

A heat-insulating layer is here applied to the surface of a core element and the heat-insulating layer is again enclosed from the outside by at least one shell element, the shell element(s) predetermining the outer contour of the finished turbine blade and being correspondingly machined into shape in advance.

The core element can be produced from a suitable metal, a metal alloy, but by preference from titanium aluminide.

In one alternative, the heat-insulating layer is formed from an open-cell nickel foam, which is known per se and commercially available, as far as possible the entire surface of the open-cell foam, i.e. also the surfaces of the internal webs, having been coated in advance with a nickel-base alloy or TiAl.

The at least one or also two shell elements is/are then also integrally connected from the outside to the heat-insulating layer by sintering and the shell element(s) should here also consist of a nickel-base alloy; in the preferred embodiment, the nickel-base alloy used for the surface coating of an open-cell foam should have the same alloy composition as that of the shell element(s).

On a finished turbine blade, the heat-insulating layer should have a thickness in the range between 1 and 5 mm, preferably less than 2 mm, the respective thickness of the heat-insulating layer being able to be selected taking into account the temperatures of the turbine blades in use and their respective dimensions.

Moreover a porosity of the heat-insulating layer, which is formed from a surface-coated foam, of 85 to 95% is preferably to be maintained, porosities in the range between 90 and 95% being preferred.

The shell elements which are to be secured to a turbine blade according to the invention by means of an integral connection can have a relatively small thickness of for example 1 mm or less than 1 mm since they must substantially fulfil the function of a surface which is advantageous in terms of fluidics on such a turbine blade. To this end, shell elements should abut practically gap-free against their end-face contact surfaces and/or such contact surfaces of adjacent shell elements should be arranged in regions of the turbine blades which are not critical or only slightly critical in terms of fluidics when the blades are operated.

Thus the end faces, in contact with and abutting against each other, of adjacent shell elements can be chamfered in respectively opposite directions such that a practically absolutely completely tight seal can be achieved between the exterior environment and the heat-insulating layer.

However, incisions or recesses can also be formed on such end faces, such that during a sintering procedure through holes are present between adjacent shell elements through which gases, previously released during a binder removal process, can escape to the outside. These through holes can, however, subsequently be closed again during the sintering process, a point which will be returned to in the explanation of a method for manufacturing the turbine blades according to the invention.

The manufacture of such turbine blades according to the invention can take place in such a way that a core element is used, the outer contour of which is preferably already matched to the outer end contour of the turbine blade in correspondingly reduced dimensions.

A blank of an open-cell nickel foam, which has an appropriate constant thickness, is prepared in advance and so cut out that the surface of the core element is as far as possible completely covered with the open-cell nickel foam using such a blank.

The blank of the open-cell nickel foam thus prepared is then coated with a suspension or mixture which contains the respective powdered nickel-base alloy or TiAl as well as a binder solution.

In the event that, as explained previously, a nickel foam is to be coated, it is advantageous to use an alloy which is low in nickel for the suspension for forming the coating. The alloy should here contain a nickel portion of 20 to 40% by weight in addition to other alloy elements which are selected from carbon, chromium, molybdenum, iron, cobalt and niobium. By this means, after the sintering process, the heat-insulating layer can be obtained from a nickel alloy with a higher proportion of nickel by alloying on from the nickel foam.

However, instead of an open-cell foam of pure nickel, an open-cell foam of a nickel-base alloy can also be used for the heat-insulating layer system. Such an open-cell foam of a nickel-base alloy can then be formed from the elements which are to be mentioned later for a preferred use for producing a suspension from a corresponding powder.

An open-cell foam of a nickel-base alloy can, however, also be coated with a suspension and integrally connected to the core element and shell elements by sintering, and this suspension can contain titanium aluminide powder with an aluminium content of 25 to 75% by weight instead of powdered nickel-base alloy. In addition to titanium aluminide, chromium, niobium, molybdenum, manganese, copper, silicon and/or bismuth can also be contained as additional alloy elements.

In contrast to an integral connection to be produced by sintering with a nickel-base alloy, as will be gone into more explicitly later, in the case of sintering with titanium aluminide, the following parameters are used.

The sintering takes place at temperatures of between 1250 and 1330° C.; the heating rate should be 5K/min and the retention time 20 to 60 minutes.

Moreover, it is advantageous to carry out the sintering in an inert atmosphere or under a high vacuum.

The preferred manner of coating is immersing the open-cell nickel foam in the suspension and, if necessary, subsequently removing excess suspension from the surfaces of the nickel foam.

The uniformity of the surface coating of the open-cell nickel foam with the suspension can be supported by vibration.

The blank thus prepared, e.g. of open-cell nickel foam, can then be placed on the surface of the core element which has previously been provided with a thin layer of the same suspension, for example by spraying.

Thereafter the at least one or also a plurality of shell elements is applied, the inner surfaces of which, i.e. the surfaces which point towards the heat-insulating layer to be formed from the open-cell nickel foam, have also been coated with the same suspension, and this can also have been achieved by spraying.

The composite part thus prepared, which is formed from the core element, the surface-coated open-cell nickel foam and the respective shell element(s), is then sintered, binder being simultaneously removed well before the maximum sintering temperature is reached which is usually above 1000° C.

In this process at least all the organic components are driven out, being able then also to escape from the inside of the turbine blade through the already-mentioned through holes formed by the incisions and recesses on end faces of shell elements.

As the temperature is increased, the surface coating is then formed from the powdered nickel-base alloy on the open-cell nickel foam and the nickel foam forming the heat-insulating layer is then integrally connected on the inside to the core element and on the outside to the shell element(s) during the sintering process.

In the event that shell elements with recesses or incisions forming through holes have been used, these can also be closed during the sintering process by caking of the powdered nickel-base alloy, it being possible then subsequently to carry out in these regions mechanical after-treatment by grinding or even polishing leading to smoothing of the surfaces.

The sintering can be carried out at temperatures in the range between 1150 and 1250° C.; a heating rate of 5 K/min and a retention time in the range between 20 and 60 minutes at the maximum sintering temperature should be adhered to during the sintering process.

Moreover it is advantageous to carry out the sintering in a reducing atmosphere, preferably hydrogen.

A powdered nickel-base alloy containing at least 50% by weight nickel should be used to produce the suspension for the coatings. Additional alloy elements can be selected from the elements carbon, chromium, molybdenum, iron, cobalt, niobium and nickel.

It is advantageous to use a nickel-base alloy which contains, as well as at least 55% by weight nickel, at least 15% by weight chromium and at least 5% by weight molybdenum.

The invention will be explained below through an example of the manufacture of a turbine blade according to the invention.

A powdered nickel-base alloy containing 58.6% by weight nickel, 0.1% by weight carbon, 22.4% by weight chromium, 10.0% by weight molybdenum, 4.8% by weight iron, 0.3% by weight cobalt and 3.8% by weight niobium is used to produce a suspension. The powder had a mean particle size of 35 μm.

For coating an open-cell nickel foam, which had an initial porosity of 94% and a thickness of 1.9 mm, a 1% aqueous solution of polyvinyl pyrrolidone was added to the powdered nickel-base alloy.

The open-cell nickel foam was then immersed in the suspension and thereafter pressed against an absorbent substrate in order to remove excess suspension, especially from the open cells of the nickel foam, but an at least almost complete wetting even of the webs inside the open-cell nickel foam structure should be maintained.

As an alternative, however, the coating of the surfaces of the open-cell nickel foam can also be carried out in such a way that the open-cell nickel foam is immersed on its own in a binder solution, a 1% aqueous polyvinyl pyrrolidone solution, and subsequently pressed, and only then is the powdered nickel-base alloy scattered dry on the surfaces of the open-cell nickel foam which are provided with the binder solution, it being possible to achieve a uniform distribution of the powder through vibration. In this way, the powder particles cover the cellular network of the nickel foam and consequently also the internal webs at least almost completely and at the same time the open-cell character of the nickel foam is preserved.

Thereafter the outer surface of the core element and the inner surfaces of the respective shell elements are then coated with the suspension of the powdered nickel-base alloy and the 1% aqueous solution of polyvinyl pyrrolidone by spraying. The layer thicknesses of this suspension should be in the range between 50 and 200 μm, preferably 150 μm.

Then the surface-coated nickel foam is placed on the surface of the core element and the shell elements are so pressed on from the outside that the surface-coated nickel foam then forming the ultimate heat-insulating layer is enclosed between the core element and the shell elements, touching them all.

The semi-finished product in the form of a composite part thus prepared is then introduced into a sintering furnace in which a hydrogen atmosphere is maintained.

In this process, the binder is removed in the temperature range between approx. 300 and 600° C.

The process was carried out with a heating rate of 5 K/min and the sintering in the temperature window from 1150 to 1250° C. with a retention time of 30 minutes. A retention time of approximately 30 minutes in the described temperature window during the binder-removal process should also be taken into account.

After the sintering, the heat-insulating layer formed from the surface-coated open-cell nickel foam still has a porosity of 91%, such that very good heat insulation and uniform temperature distribution could be achieved over the entire volume of the turbine blade.

The turbine blade thus produced had a significantly reduced thermomechanical fatigue, such that its service life could be increased by comparison with conventional turbine blades. Moreover very good resistance to oxidation in air was achieved at temperatures of up to 1050° C., with increased strength, creep resistance and toughness.

Moreover, calibration of the turbine blade according to the invention thus produced is also possible after sintering. This takes place via subsequent pressing in a compression mould in order to even out dimension tolerances which could still be present after sintering.

1. Turbine blade for turbo-engines comprising a heat-insulating layer of a metallic open-cell foam which is integrally connected by sintering to the surface of a core element; and the outer contour of the turbine blade is formed with at least one shell element made of a nickel-base alloy, also integrally connected by sintering to the open-cell foam which forms the heat-insulating layer.

2. Turbine blade according to claim 1, characterized in that the core element is formed from titanium aluminide.

3. Turbine blade according to claim 1, characterized in that the heat-insulating layer has a thickness in the range between 1 and 5 mm.

4. Turbine blade according to claim 1, characterized in that the open-cell foam is formed from a nickel-base alloy or from an open-cell nickel foam which is surface-coated with a nickel-base alloy.

5. Turbine blade according to claim 1, characterized in that the heat-insulating layer is formed from an open-cell nickel foam which is surface-coated with TiAl, or from an open-cell foam of a nickel-base alloy coated in the same way.

6. Turbine blade according to claim 5, characterized in that, for the surface coating, TiAl is formed with an aluminum content which is in the range between 20 and 75% by weight and additional alloy elements which are selected from chromium, niobium, molybdenum, manganese, copper, silicon and bismuth.

7. Turbine blade according to claim 1, characterized in that the heat-insulating layer has a porosity of between 85 and 98%.

8. Method for manufacturing turbine blades according to claim 1, characterized in that an open-cell metallic foam, as a blank of constant thickness, is coated with a suspension or mixture formed from a powdered nickel-base alloy or TiAl and a binder solution, such that the surface of the foam with its webs has been wetted, the outer surface of a core element and the inner surface of at least one shell element, predetermining the outer contour of the turbine blade, are coated with the same suspension, then the coated core element, the foam and the shell element(s) are brought into contact with one another, such that the foam is enclosed between the core element and the shell elements to form the heat-insulating layer, and the composite part thus obtained is so sintered that the core element, the heat-insulating layer formed from the open-cell, surface-coated foam, and the shell elements are integrally connected to each other.

9. Method according to claim 8, characterized in that the sintering takes place as compressive force is applied from the outside to the shell elements.

10. Method according to claim 8, characterized in that an aqueous solution of polyvinyl pyrolidone containing a powdered nickel-base alloy or TiAl is used.

11. Method according to claim 8, characterized in that the open-cell foam is coated by immersion in the suspension and subsequent removal of excess suspension.

12. Method according to claim 8, characterized in that the sintering is carried out up to a maximum temperature of between 1150 and 1350° C.

13. Method according to claim 12, characterized in that the maximum sintering temperature is maintained over a period of 20 to 60 minutes.

14. Method according to claim 8, characterized in that the sintering is carried out in a reducing or inert atmosphere.

15. Method according to claim 8, characterized in that a nickel-base alloy comprising at least 50% by weight nickel and additional alloy elements, selected from carbon, chromium, molybdenum, iron, cobalt, niobium and nickel is used for the suspension.

16. Method according to claim 8, characterized in that a low-nickel alloy with the alloy elements, selected from carbon, chromium, molybdenum, iron, cobalt, niobium and nickel in a proportion of 20 to 40% by weight is used for the suspension.

17. Method according to claim 15, characterized in that a nickel-base alloy comprising at least 55% by weight nickel, at least 15% by weight chromium and at least 5% by weight molybdenum is used.
